(19) United States
(12) Patent Application Publication
(10) Pub. No.: US 2008/0084131 A1
(43) Pub. Date: Apr. 10, 2008

(54) Stepping Motor

(75) Inventors: Takayuki Yamawaki, Shizuoka (JP); Toshihiko Nagata, Shizuoka (JP)

Correspondence Address: FOLEY AND LARDNER LLP;SUITE 500, 3000 K STREET NW, WASHINGTON, DC, 20007, US

(73) Assignee: MINEBEA-MATSUSHITA MOTOR CORPORATION

(21) Appl. No.: 11/659,845

(22) PCT Filed: Aug. 9, 2005
(86) PCT No.: PCT/JP05/14572

§ 371 Date: Feb. 9, 2007

(30) Foreign Application Priority Data
Aug. 12, 2004 (JP) 2004-235084

(51) Int. Cl. H02K 5/00; H02K 37/12; H02K 5/02; H02K 5/16

(52) U.S. Cl. 310/89; 310/43; 310/49 R

(57) ABSTRACT

A stepping motor is provided and includes: a rotor; a stator comprising a stator yoke having pole teeth; and a molded case comprising a case body and a mounting flange. The case body is resin-molded such that outer faces of the pole teeth of the stator yoke are exposed, and the mounting flange is resin-molded integrally with the case body.

### BACKGROUND OF THE INVENTION

1. Field of the Invention

The present invention relates to a stepping motor, in which a mounting flange is formed in an arbitrary shape and at an arbitrary location, and also in which cooling capability is enhanced.

2. Description of the Related Art

Traditionally, when a case is formed by resin molding, a coil and a yoke have been resin-molded integrally with the case (refer to, for example, Patent Documents 1 to 3).

Also, a mounting flange has been resin-molded with the case, instead of a metallic mounting flange discretely provided previously (refer to, for example, Patent Documents 1 and 2).

FIGS. 7A to 7D show traditional stepping motors in which a coil and other components are resin-molded integrally with a case, wherein FIGS. 7A and 7B show an example stepping motor as disclosed in the aforementioned Patent Document 1, FIG. 7C shows an example stepping motor as disclosed in the Patent Document 2, and FIG. 7D shows an example stepping motor as disclosed in the Patent Document 3.

In the stepping motor shown in FIGS. 7A and 7B, a mounting flange is resin-molded integrally with a case body, specifically a mounting flange 101 is formed by resin molding at a place of a case 102, which is recessed from an end surface 103 of a protruding shaft side so as to shift toward coil terminals 104.

In the molding process, when the mounting flange 101 is formed, gaps between pole teeth 105 are filled up with resin simultaneously. A first magnetic pole unit 106 is formed such that an inner magnetic pole section is press-fitted into a coil thus forming a pre-assembly, then the pre-assembly is put in a molding die so as to have its outer circumference covered with resin, and that the gaps between the pole teeth 105 are filled with resin by injection molding. A chassis plate 110 of a main device, to which the stepping motor is attached, includes a hole to engage with a circular boss 109 formed at the protruding shaft side of the case 102, and also a locking hook 112 to fixedly hold the stepping motor with respect to the axial direction. The mounting flange 101 includes a notch 111 for positioning the stepping motor with respect to the rotation direction. The stepping motor is attached to the main device such that the circular boss 109 of the stepping motor is fitted into the hole of the chassis plate 110 of the main device, and that the mounting flange 101 is fixedly held by the locking hook 112.

Also, in the stepping motor shown in FIG. 7C, a mounting flange 123 is formed by resin molding simultaneously when a stator winding 121 and a stator core 122 are molded with resin 125. A bearing housing 124 of a case is formed so as to protrude from the surface of the mounting flange 123.

On the other hand, a molded stator structure has traditionally been employed generally, in which a stator yoke and a coil are sealed with resin mold material so that heat generated inside the stator is radiated via the resin mold material (refer to, for example, the Patent Document 3).

Referring to FIG. 7D presenting an example disclosed in the Patent Document 3, a traditional mold stator structure adapted to radiate heat generated inside the stator is shown.

Generally in a motor in which a stator yoke 131 and a coil 132 are resin-molded, for example, heat generated at the stator yoke 131 and the coil 132 conducts mostly via mold resin 133 to a bracket 134, and then is radiated therefrom. The heat conducts via the wire of the coil 132 in the axial direction and is radiated. Natural radiation form the mold resin 133 to the outside atmosphere is hardly anticipated to occur. Therefore, it is important for cooling performance how heat generated at the stator yoke 131 and the coil 132 is conducted to the bracket 134.

Specifically, the coil 132 is wound around an insulating coil bobbin (not shown). The coil 132 is made of electrolytic copper as a good heat conductor and has its circumferential area covered with an insulating coat. Consequently, heat generated at the coil 132 is caused to conduct mostly in the axial direction that provides a favorable heat conductance, and so conducts to the mold resin 133 from the end of the coil 132.

Since the insulating bobbin material has a heat conductivity that is definitely lower than the heat conductivity the coil 132 has with respect to the axial direction, the heat generated at the coil 132 is caused to radiate from its end portion.

Also, since an electromagnetic steel plate for the stator yoke 131 has its surface covered with an insulating coat, a laminated body composed of such electromagnetic steel plates stacked in the axial direction provides a heat conductivity which is significantly lower with respect to the axial direction than with respect to the circumferential and radial directions. Consequently, heat generated at the coil 132 is caused to travel in the radial direction rather than in the axial direction so as to conduct via the mold resin 133 to the bracket 134. The bracket 134 is made of metal, and so the heat conductivity of the mold resin 133 is lower than that of the bracket 134. Thus, it is important how the heat generated at the coil 132 is conducted to the bracket 134.

As described above, if the heat conductivity of the mold stator is improved with respect to the axial direction, the cooling capability of an armature composed of the coil and the yoke which are resin-molded together is enhanced, whereby the armature, which is heated to the highest temperature among motor constituent parts, is effectively cooled down, and therefore the entire motor can be efficiently cooled down.

(Patent Document 1) JP-A-2003-209948

(Patent Document 2) JP-A-7-75280

(Patent Document 3) JP-A-2003-231192

However, the mounting flange shown in FIGS. 7A and 7B is formed at a location recessed from the axial end face of the case so as to shift closer to the coil terminal so that the bearing and a portion of the case are caused to protrude axially from the mounting flange and stand in the way when the mounting flange is attached to the chassis palate of the main device. Also, the shape of the mounting flange is subjected to limitation.

Also, a molded stator structure has traditionally been employed generally, in which a stator yoke and a coil are sealed with resin mold material so that heat generated inside the stator is radiated via the resin mold material, but this structure provides a very low heat conductance with respect to the axial direction and has a limitation in achieving reduction in size and weight of a motor in which heat is radiated via molding resin. Also, resin mold material is provided entirely around the stator yoke.

Heat generated at the stator yoke and the coil travels through mold resin at the circumferential area, and arrives at a mounting flange via a bracket. But, if the mounting flange is formed of resin, the heat generated is prevented from duly conducting by the case and also the flange, thus making the heat radiation difficult.

### SUMMARY OF THE INVENTION

An object of the present invention is to provide a stepping motor, in which a resin mounting flange is formed in an arbitrary shape and at an arbitrary location of a molded case, and also in which cooling capability is enhanced regardless of the location of the resin mounting flange.

In order to achieve the object described above, the present invention provides the following solutions.

The outer faces of pole teeth of a stator yoke are exposed at the circumferential surface of a molded case. The number and arrangement of the pole teeth having their outer faces exposed may be determined in consideration of heat radiation efficiency. If a mounting flange is located at such a place of the molded case as to have its base portion occupying the region of the outer faces of the pole teeth, the mounting flange may be formed such that the interface area of the base portion with the molded case is determined with attachment strength in mind. Preferably, the mounting flange is formed at the molded case such that the base portion keeps clear of the pole teeth.

The shape and thickness of the mounting flange and also the shape of an opening of the mounting flange for insertion of a mounting screw may be arbitrarily and optimally determined. And, the base portion of the mounting flange may be located at any place of the molded case, at which resin mold formation is possible for appropriately connecting between the mounting flange and the molded case.

If the main device to which the stepping motor is attached incorporates a bearing, the stepping motor may include only one bearing. This reduces the axial dimension and also the weight of the stepping motor.

Also, heat generated at a coil and other components may be caused to conduct via the bearing so as to be radiated from the end face of the bearing exposed at the outer surface of the molded case.

And, the aforementioned heat generated may be radiated from the outer face of a circular ring plate of a stator yoke exposed at the outer surface of the molded case.

The solutions will be specifically described as follows.

(1) A stepping motor is provided which includes: a rotor; a stator including a stator yoke having pole teeth; and a molded case including a case body and a mounting flange, wherein the case body is resin-molded such that the outer faces of the pole teeth of the stator yoke are exposed, and wherein the mounting flange is resin-molded integrally with the case body.

(2) In the stepping motor as cited in description (1), the rotor includes a rotor magnet and a rotary shaft, and the end face of one of a pair of bearings to support the rotary shaft is exposed from the case body.

(3) In the stepping motor as cited in description (2), the outer surface of a circular ring plate of the stator yoke is exposed at the axial direction end surface of the case body.

(4) In the stepping motor as cited in any one of descriptions (1) to (3), the mounting flange is formed at the case body so as to keep clear of the pole teeth of the stator yoke.

(5) In the stepping motor as cited in any one of descriptions (1) to (4), the mounting flange is formed at an arbitrary position of the case body with respect to its axial direction.

### BRIEF DESCRIPTION OF THE DRAWINGS

FIG. 1 is a perspective cutaway view of a first stepping motor according to the present invention, which includes a pair of bearings;

FIG. 2 is a perspective view of the first stepping motor;

FIG. 3 is a perspective cutaway view of a second stepping motor according to the present invention, which includes one bearing;

FIG. 4 is a perspective view of the second stepping motor;

FIG. 5 is a perspective cutaway view of a third stepping motor according to the present invention, which includes one bearing and which has its mounting flange arranged at a different position;

FIG. 6 is a perspective view of the third stepping motor; and

FIGS. 7A to 7D show traditional stepping motors in which a coil and other components are resin-molded integrally with a case.

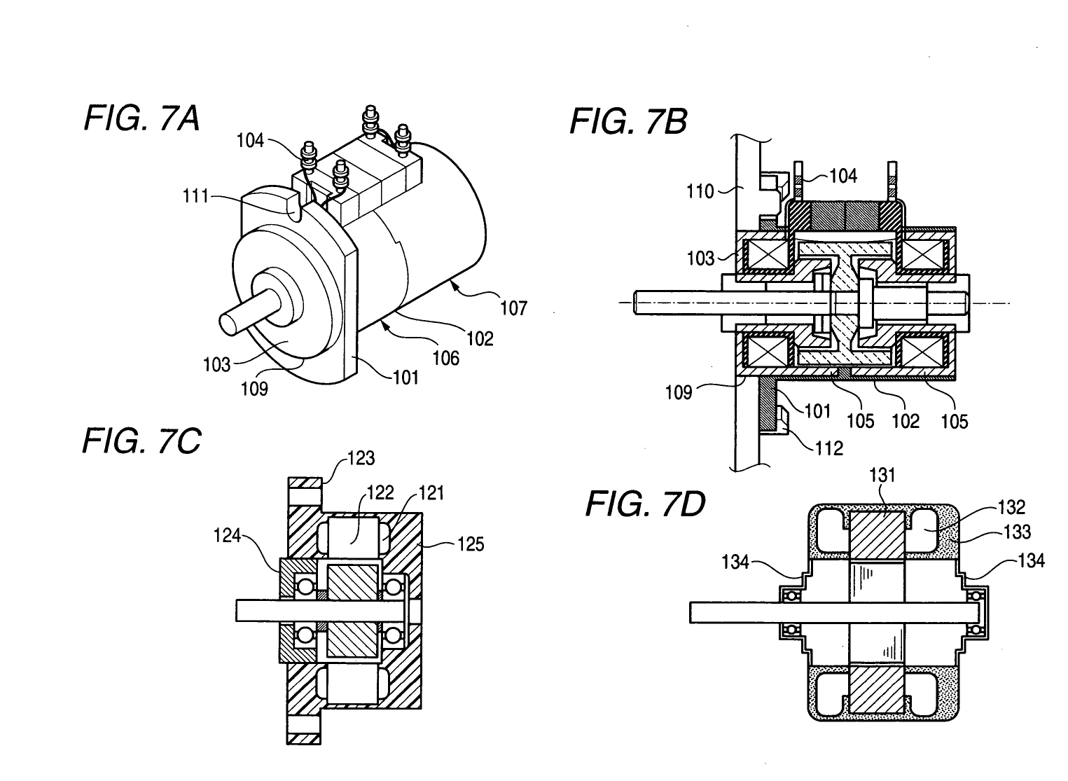

### DETAILED DESCRIPTION OF THE EXEMPLARY EMBODIMENTS

In a traditional stepping motor, heat generated at a coil and a stator yoke is caused to conduct radially via resin-molded parts, but the heat is poorly radiated from a resin-molded case and therefore is forced to stay thereinside. On the other hand, in a stepping motor according to the present invention, heat generated at a coil and a stator yoke which are heat sources is adapted to conduct via a short pathway so as to be released directly from the outer faces of the pole teeth of the stator yoke exposed at the outer circumferential surface of the molded case, and also to conduct via a bearing communicating with the stator yoke so as to be released from the end face of a bearing exposed at the outer surface of the molded case. The heat conducting via the bearing is also adapted to conduct to a rotary shaft so as to be released therefrom. Thus, while the heat generated inside is poorly released outside due to the molded case covering the outer faces of the pole teeth of the stator yoke in the traditional stepping motor, the molded case in the stepping motor of the present invention does not cover the outer faces of the pole teeth of the stator yoke, which allows reduction of the thickness of the molded case thereby achieving reduction in size and weight of the stepping motor as well as effective cooling of the coil and stator yoke.

The mounting flange can be formed flush with the end face of the molded case at the protruding shaft side in the stepping motor of the present invention, rather than formed at a location recessed from the end face of the molded case at the protruding shaft side so as to shift toward coil terminals in the traditional stepping motor. Consequently, the bearing and the bearing housing which protrude axially from the surface of the mounting flange are eliminated, no special structure is required for attaching the stepping motor to the chassis plate of the main device, and the axial dimension of the stepping motor can be reduced.

When the main device to which the stepping motor is attached includes a member or structure to function practically as a bearing, one of the bearings of the stepping motor may be eliminated thereby reducing the axial dimension of the stepping motor.

And, since the gap spaces between the pole teeth are filled with resin, noises are reduced which are generated by the stator cores making contact with each other due to electromagnetic vibrations caused during the rotation of the stepping motor.

Embodiments of the present invention will hereinafter be described in detail with reference to the accompanying drawings.

### Embodiment 1

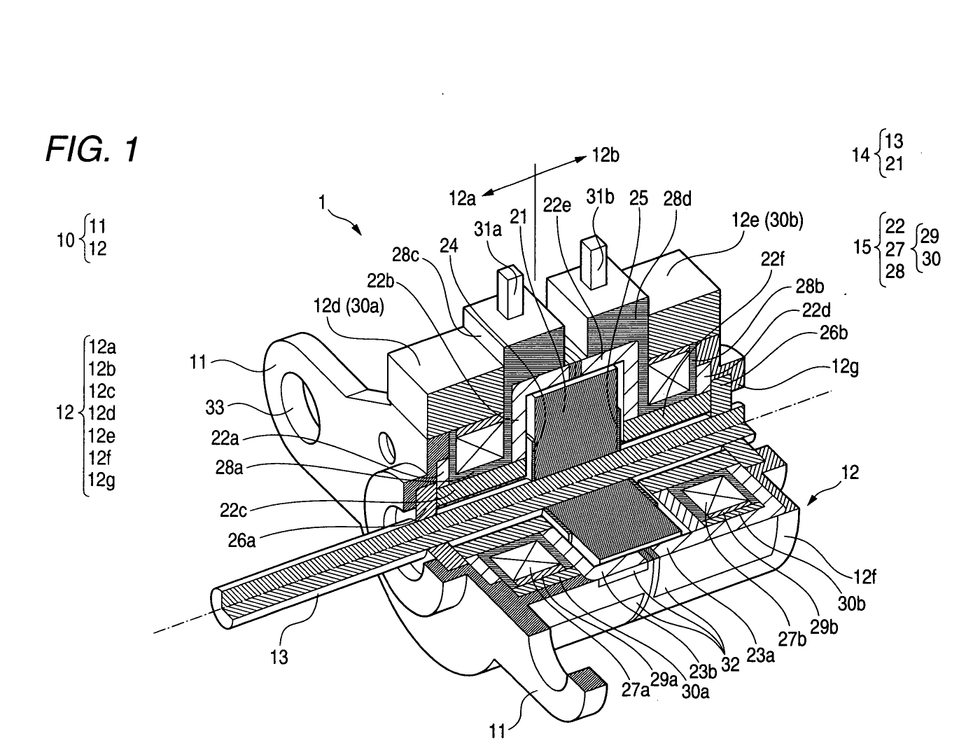

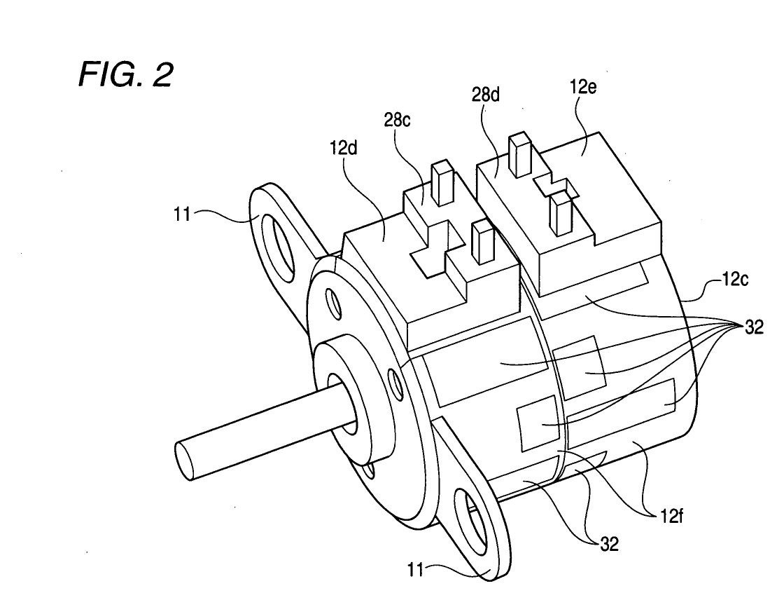

FIG. 1 is a perspective cutaway view of a stepping motor according to the present invention which includes a pair of bearings, and FIG. 2 is a perspective view of the aforementioned stepping motor.

Referring to FIGS. 1 and 2, a stepping motor according to a first embodiment of the present invention is a claw pole type stepping motor, and includes a mounting flange 11, which is provided at (or close to) an end of a case body 12 of a molded case 10 (the end of the cases body is positioned toward a portion of a rotary shaft 13 protruding from the molded case 10).

The stepping motor generally includes a rotor 14 and a stator 15, as well as the aforementioned molded case 10 including the mounting flange 11 and the case body 12.

The rotor 14 includes a substantially cylindrical rotor magnet 21 and the aforementioned rotary shaft 13. The rotor magnet 21 is made of a ferromagnetic material, has a throughhole at its center, and has at its periphery N magnetic poles and S magnetic poles arrayed alternately in the circumferential direction. The N and S magnetic poles are formed so as to oppose pole teeth 23a and 23b of a stator yoke 22 (to be described later) arranged in a comb configuration. In the description following below, a pole tooth having a long axial dimension is denoted by 23a, and a pole tooth having a short axial dimension is denoted by 23b.

The rotor 14 is assembled such that the rotary shaft 13 is inserted into the throughhole of the rotor magnet 21, and spacers 24 and 25 each having a hole are telescoped over the rotary shaft 13 from the respective ends of the rotary shaft 13. The spacers 24 and 25 are made of resin material having a good slidability.

The stator 15 has a two-phase structure. Each phase generally includes the stator yoke 22, a coil 27, and a coil bobbin 28.

The coil 27 includes a coil winding 27a and a coil winding 27b, which are each structured such that a copper wire with an insulating coat, such as enamel, is wound with a predetermined number of turns, and which are each disposed at a groove space of the coil bobbin 28.

The coil bobbin 28 is made of insulating synthetic resin and includes two divisions which include respective coil housings 28a and 28b having a cross section of squared-U shape defining the aforementioned groove space, and respective terminal blocks 28c and 28d.

The coil housings 28a and 28b are each shaped in squared-U in cross section having an opening facing radially outwardly, and respective openings are closed by insulating sheets 29a and 29b after the coil windings 27a and 27b are put in the coil housing portions 28a and 28b. The insulating sheets 29a and 29b, together with cover rings 30a and 30b, prevent dirt, dust, moisture, or like substance from coming in and adhering to the coil 27.

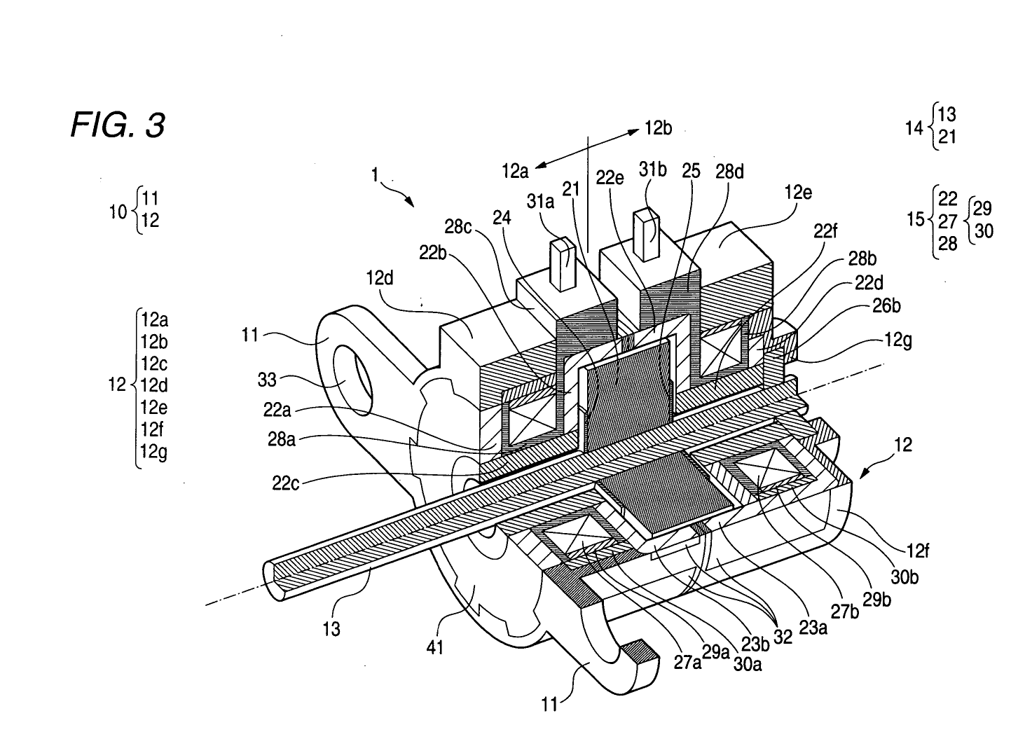

As shown in the area above the rotary shaft 13 in FIGS. 1 and 3, the terminal blocks 28c and 28d are formed in L-shape, rise respectively from the coil housings 28a and 28b each with squared-U shape cross section, and oppose each other in the longitudinal direction of the rotary shaft 13. Also, the terminal blocks 28c and 28d are arranged such that parts thereof which include respective terminals 31a and 31b protrude from the substantially cylindrical case body 12 of the molded case 10.

The stator yoke 22 includes first stator yokes 22a and 22d, second stator yokes 22b and 22e, and third stator yokes 22c and 22f, which are each made of a soft magnetic material, such as SECC (electrogalvanized steel plate), a silicon steel plate, SUY (electromagnetic soft iron plate), or the like. Each of the first stator yokes 22a and 22d is coupled to each of the second stator yokes 22b and 22e by each of the third stator yokes 22c and 22f, thereby forming each magnetic path.

The first stator yokes 22a and 22d are each structured such that a plurality of pole teeth, for example, the aforementioned pole teeth 23a, are arrayed along the circumference of a circular ring plate at regular intervals and bent up at a right angle to the circular ring plate thus forming a structure like a trivet.

The second stator yokes 22b and 22e are each structured in a similar manner to the first stator yokes 22a and 22d, specifically such that a plurality of pole teeth, for example, the pole teeth 23b, are arrayed along the circumference of a circular ring plate at regular intervals and bent up at a right angle to the circular ring plate thus forming a structure like a trivet.

The first stator yoke 22a/22d and the second stator yoke 22b/22e are disposed outside respective end walls of the coil housing 28a/28b having the coil windings 27a/27b, such that their respective pole teeth 23a and 23b intermesh with each other, and a magnetic phase difference of 180 degrees in terms of electrical angle is provided between the tips of the pole teeth 23a and 23b.

Bearings 26a and 26b are made of a sintered oil-impregnated material or like material, and such an oil containing material reduces the friction resistance.

The case body 12 of the molded case 10 is assembled by putting together a front case 12a and a rear case 12b. The front and rear cases 12a and 12b, when put together for completion, have their interface plane located substantially at the axial center of the rotor magnet 21 and oriented orthogonal to the longitudinal direction of the rotary shaft 13. Referring to FIG. 2 showing the exterior appearance of the stepping motor 1, the molded case 10 includes a substantially cylindrical portion 12c at the outer circumference surface of which outer faces 32 of the pole teeth 23a and 23b of the stator yoke 22 are exposed, and a front block 12d and a rear block 12e both disposed at an area of the substantially cylindrical portion 12c. The front and rear blocks 12d and 12e are adapted to support respectively the terminal blocks 28c and 28d of the coil bobbin 28.

The case body 12 of the molded case 10 is made of polybutylene terephthalate, liquid crystal polymer, or like material from the viewpoint of mechanical strength, and formed such that resin is filled in a molding die in which constituent parts are arranged. In this connection, when priority is given to the moldability, liquid crystal polymer is preferred for flowability reason.

The stepping motor of the present invention is incorporated in the movement mechanism of a digital camera, a video cassette recorder, or like device, and therefore is designed to have a diameter of 10 mm or less, preferably 6 mm or less, and a weight of 1 g or less. Accordingly, the molded case 10 is structured to satisfy the following considerations:

(1) The outer faces 32 of the pole teeth 23a and 23b of each stator yoke 22 are exposed at the circumferential surface 12f;

(2) The mounting flange 11 is provided at a freely and arbitrarily intended location of the case body 12 of the molded case 10 when the case body 12 is resin-molded;

(3) When the case body 12 is resin-molded, the front and rear blocks 12d and 12e are formed in succession after the formation of the terminal blocks 28c and 28d of the coil bobbin 28, and thus, the terminal blocks 28c and 28d are mechanically supported while the cover rings 30a and 30b for the coil 27 disposed around the coil bobbin 28 are formed during this process; and

(4) Molding resin is filled in the gap spaces between the pole teeth 23a and 23b of the stator yoke 22, whereby vibrations due to the electromagnetic force of the coil 27 can be efficiently reduced.

The mounting flange 11 of the molded case 10 is made of the same material as the case body 12, and has an opening 33. The opening 33 is for attachment to a main device and optimally configured for the attachment convenience.

In FIGS. 1 and 2, the mounting flange 11 is located at a place which is recessed from the very end of the case body 12 at the side of the protruding shaft 13 so as to shift toward the terminal block 28c of the coil bobbin 28 by a distance defined by the axial dimension of the bearing 26a. In the present embodiment, the main device, to which the stepping motor is attached, is supposed to have a chassis plate provided with a hole into which the circular boss of the molded case 10 of the stepping motor covering the bearing 26a is fitted.

(Method of Manufacturing a Molded Case)

Front Case (12a):

The insulating sheet 29a and the cover ring 30a are put on the coil bobbin 28a having the coil 27a disposed therearound, then the coil bobbin 28a is set on the third stator yoke 22c, and the first stator yoke 22a and the second stator yokes 22b are press-fitted into the third stator yoke 22c, thus forming a stator yoke assembly. At this time, the pole teeth 23a of the first stator yoke 22a and the pole teeth 23b of the second stator yoke 22b are positioned so as to provide a phase difference therebetween by an electrical angle of 180 degrees.

Next, the bearing 26a is set at a predetermined position inside a molding die (not shown), and the stator yoke assembly described above is placed on the bearing 26a.

Means are set in the molding die, which prevent resin from reaching any areas at which mold formation must be avoided, for example, the outer faces 32 of the pole teeth 23a and 23b. The means may be, for example, the wall of the molding die, and cores. Then, resin is filled into the molding die.

As a result, the stator yoke assembly and the mounting flange 11 can be integrally molded, and the terminal block 28c of the coil bobbin 28a is supportedly secured to the mounting flange 11 via the front block 12d.

Also, the pole teeth (identical in shape with the pole teeth 23a) of the first yoke 22a and the pole teeth 23b of the second stator yoke 22b are fixedly settled by molding resin so as to reduce vibrations.

(Formation of a Flange)

If the base portion (joining the molded case 10) of the mounting flange 11 is structured to occupy the area of the circumferential surface 12f of the case body 12 at which the outer faces 32 of the pole teeth 23a and 23b of the stator yoke 22 are supposed to be exposed, the section area of the base portion may be decreased to a certain extent with the requisite minimum mechanical strength taken into consideration, or the mounting flange 11 may be arranged such that the base portion keeps clear of the outer faces of the pole teeth 23.

Rear Case (12b):

The insulating sheet 29b and the cover ring 30b are put on the coil bobbin 28b having the coil 27b disposed therearound, then the coil bobbin 28b is set on the third stator yoke 22f, and the first stator yoke 22d and the second stator yokes 22e are press-fitted into the third stator yoke 22f, thus forming a stator yoke assembly. At this time, the pole teeth 23a of the first stator yoke 22d and the pole teeth 23b of the second stator yoke 22e are positioned so as to provide a phase difference therebetween by an electrical angle of 180 degrees.

Next, the bearing 26b is set at a predetermined position inside a molding die (not shown), and the stator yoke assembly described above is placed on the bearing 26b.

Means are set in the molding die, which prevent resin from reaching the outer faces of the pole teeth 23a and 23b at which mold formation must be avoided. Resin is filled into the molding die.

As a result, the bearing 26b can be fixedly set at a rear end plate 12g, and the terminal block 28d of the coil bobbin 23 is supportedly secured to the rear end plate 12g via the rear block 12e.

Also, the pole teeth 23a of the first yoke 22d and the pole teeth 23b of the second stator yoke 22e are fixedly settled by molding resin so as to reduce vibrations.

Putting Together Front and Rear Cases:

The front and rear cases 12a and 12b, which are separately prepared, are put together such that their respective open mouth ends are jointed to each other so as to enclose the constituent parts of the rotor 14 as shown in FIG. 1 or 3, and are fixedly engaged with each other, thus completing the molded case 10. If necessary, resin is filled in a gap possibly present at the joint between the open mouth ends of the front and rear cases 12a and 12b.

(Cooling)

Description will now be made on the heat radiation structure of the stepping motor according to the first embodiment of the present invention.

The stepping motor according to the first embodiment is structured such that plurality of stator yokes 22 are provided in contact with the coil bobbin 28 having the coil 27, the outer faces 32 of the pole teeth 23a and 23b of the stator yokes 22 are flush (identical surface level) with the circumferential surface 12f of the molded case 10 so as to be exposed, and that the bearings 26a and 26b are partly exposed at the respective end faces of the case body 12.

Since the outer faces 32 of the plurality of pole teeth 23a and 23b of the stator yokes 22 are arranged to be flush with the circumferential surface 12f of the molded case 10 so as to be exposed thereat as described above, heat generated inside the molded case 10 can be radiated from the outer faces 32 of the pole teeth 23a and 23b. The exposed outer faces 32 of the pole teeth 23 and 23b are provided in large numbers at the circumferential surface 12f of the case body 12 of the molded case 10 except the front and rear blocks 12d and 12e, and therefore the stepping motor can be effectively cooled by way of a short path.

Also, the heat generated is conducted to the bearings 26a and 26b and radiated from the ends of the bearings 26a and 26b which exposedly protrude from the respective ends of the case body 12 of the molded case 10.

(Vibration)

Since resin is filled in the gaps between the pole teeth 23a and the pole teeth 23b, the vibrations of the pole teeth 23a and 23b can be suppressed by the resin filled. Also, the vibrations generated at the pole teeth 23 and 23b are to some extent released into the air from the outer faces 32 of the pole teeth 23a and 23b exposed at the circumferential surface 12f of the molded case 10, and are thereby reduced. Thus, the stepping motor according to the first embodiment achieves reduction in vibrations and noised as well as improvement in cooling capability.

### Embodiment 2

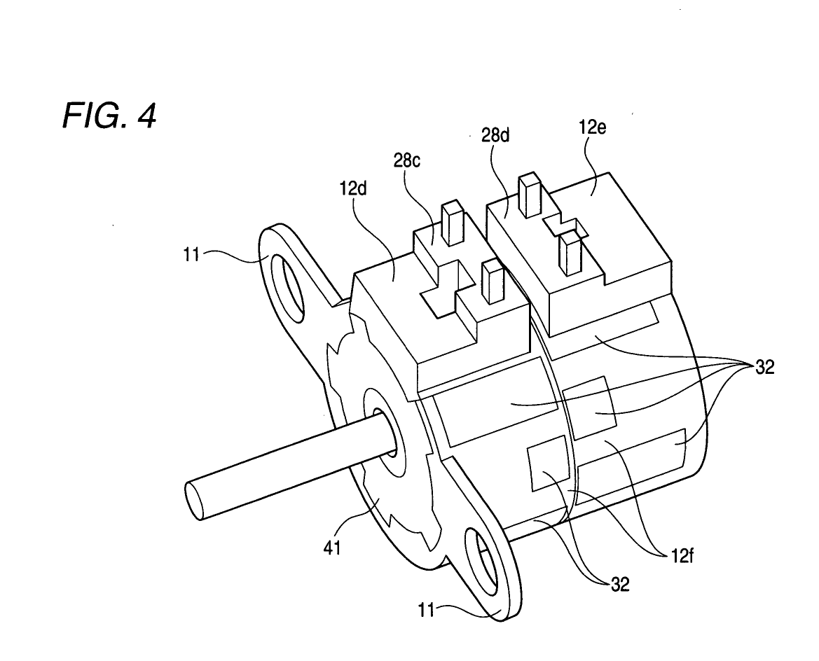

FIG. 3 is a perspective cutaway view of another stepping motor according to the present invention, which is the same as the stepping motor of FIG. 1 but omits one bearing, specifically the bearing 26a, and FIG. 4 is a perspective view of the aforementioned stepping motor.

Referring to FIGS. 3 and 4, a stepping motor according to a second embodiment of the present invention includes a mounting flange 11, which is located at the very end of a case body 12 of a molded case 10.

The second embodiment refers to a modification of the stepping motor of the first embodiment, where the face of a circular ring plate 41 of a first stator yoke 22a and the end face of a second stator yoke 22c are exposed. Specifically, in the modification, the bearing 26a at the protruding side of a rotary shaft 13 incorporated in the first embodiment is now eliminated, and a portion of the molded case 10, which is adapted to cover the bearing 26a of the first embodiment, and which includes a plane corresponding to its interface with the stator yoke 22, is removed with no portion of the mounting flange 11 remaining to exist at the plane.

The second embodiment is applicable when the main device to which the stepping motor of the present invention is attached has a member or structure to function practically as a bearing (not shown) to rotatably support the protruding side of the rotary shaft 13, thus requiring only one bearing in the stepping motor. The other parts in the second embodiment than those described above are the same as the parts described in the first embodiment and are denoted by the same symbol, and therefore explanation thereof will be omitted.

### Effects of the Second Embodiment

Since the circular ring plate 41 of the first stator yoke 22a is exposed at the axial end face of the molded case 10, heat radiation effect is enhanced, wherein the effect is achieved in a magnitude proportional to the surface size of the circular ring plate 41.

Since a portion of the molded case 10 corresponding to the bearing used in the first embodiment but now eliminated is removed, the molded case 10 has its axial dimension and weight reduced, whereby the molded case 10 can fit into a smaller space.

### Embodiment 3

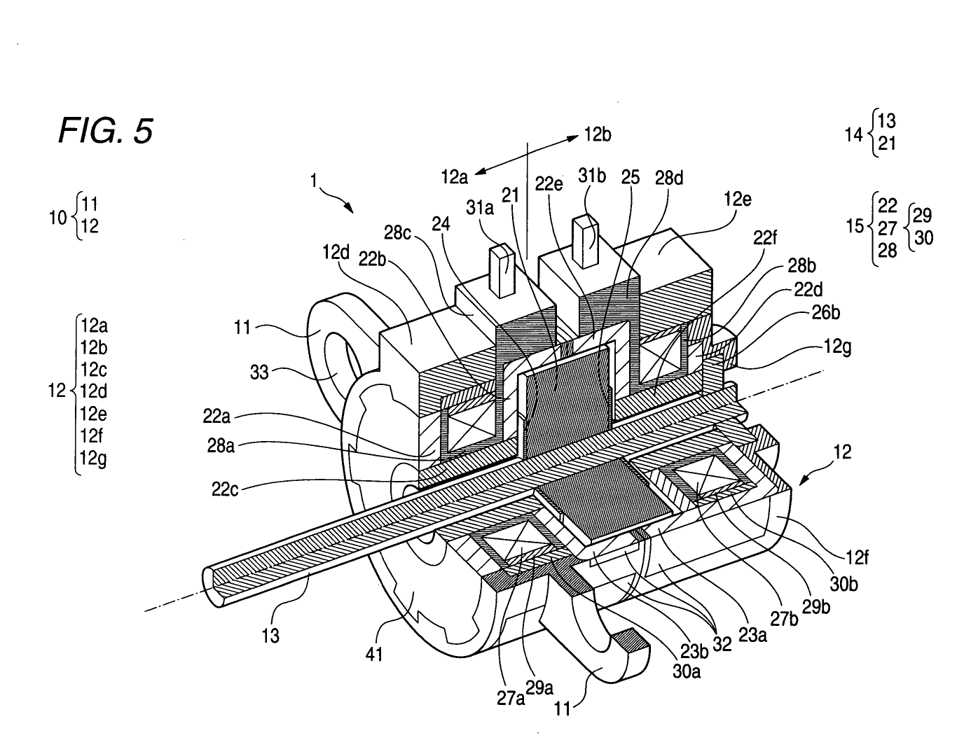

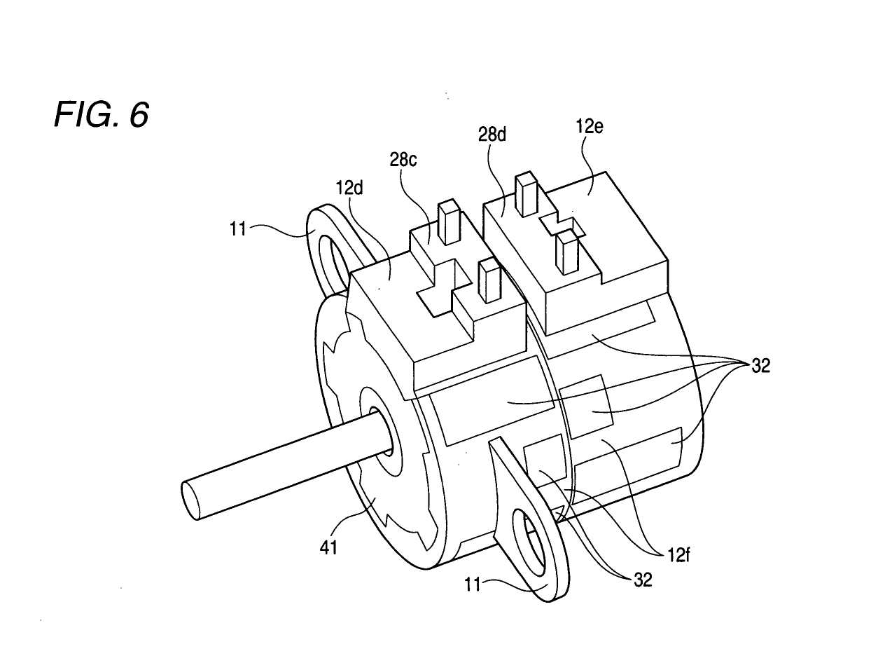

FIG. 5 is a perspective cutaway view of still another stepping motor according to the present invention, in which one of the two bearings used in the first embodiment is omitted, and a mounting flange is located at a different area of a case body, and FIG. 6 is a perspective view of the aforementioned stepping motor. Specifically, FIGS. 5 and 6 show an example of a third embodiment, in which the location of the mounting flange shown in FIG. 3 is shifted from one end of the molded case toward the center.

In the third embodiment of the present invention, a mounting flange 11 is disposed at a location closer to the axial center of a molded case 10 as compared to the second embodiment.

If the mounting flange 11 is located such that the base portion thereof covers pole teeth 23a and 23b of a stator yoke 22, then the area of the base portion joining to a case body 12 of the molded case 10 and also the dimensional ratio of the area are determined in consideration of the cooling effect and the attachment strength. Preferably, the mounting flange 11 is formed such that the base portion thereof keeps clear of the pole teeth 23a and 23b of the stator yoke 22.

### Effects of the Third Embodiment

Since a circular ring plate 41 of a first stator yoke 22a is exposed at the axial end face of the molded case 10, heat radiation effect is enhanced, wherein the effect is achieved in a magnitude proportional to the surface size of the circular ring plate 41.

Since a portion of the molded case 10 corresponding to the bearing used in the first embodiment but now eliminated is removed, the molded case 10 has its axial dimension and weight reduced, whereby the molded case 10 can fit into a smaller space.

Since the mounting flange 11 can be formed at an arbitrary location of the molded case 10 with respect to the axial direction, the stepping motor can be flexibly attached to the main device according to the attachment mode of the main device.

While the stepping motor of the present invention has been described with reference to the exemplary embodiments, the constituent elements can be replaced with any components that are duly capable of fulfilling the desired functions.

1.-9. (canceled)

10. A stepping motor comprising:
a rotor;
a stator comprising a stator yoke having pole teeth; and
a molded case comprising a case body and a mounting flange, wherein the case body is resin-molded such that outer faces of the pole teeth of the stator yoke are exposed, and wherein the mounting flange is resin-molded integrally with the case body.

11. The stepping motor according to claim 10, wherein the rotor comprises a rotor magnet and a rotary shaft, and wherein an end face of one of a pair of bearings to support the rotary shaft is exposed from the case body.

12. The stepping motor according to claim 11, wherein an outer surface of a circular ring plate of the stator yoke is exposed at an axial direction end surface of the case body.

13. The stepping motor according to claim 10, wherein the mounting flange is formed at the case body so as to keep clear of the pole teeth of the stator yoke.

14. The stepping motor according to claim 10, wherein the mounting flange is formed at an arbitrary position of the case body with respect to an axial direction of the case body.
